(19) United States
(12) Patent Application Publication
(10) Pub. No.: US 2018/0052347 A1
(43) Pub. Date: Feb. 22, 2018

(54) VA TYPE COA LIQUID CRYSTAL DISPLAY PANEL

(71) Applicant: Shenzhen China Star Optoelectronics Technology Co., Ltd., Shenzhen City (CN)

(72) Inventor: Chengzhong Yu, Shenzhen City (CN)

(21) Appl. No.: 15/031,278

(22) PCT Filed: Feb. 26, 2016
(86) PCT No.: PCT/CN2016/074622

§ 371 Date: Apr. 22, 2016

(30) Foreign Application Priority Data
Feb. 16, 2016 (CN) 201610087805.3

(51) Int. Cl. G02F 1/1368; G02F 1/1333; G02F 1/1339; G02F 1/1362; G02F 1/1343

(52) U.S. Cl. CPC G02F 1/1368; G02F 1/133345; G02F 1/1339; G02F 1/136286; G02F 1/13394; G02F 1/13439; G02F 2001/13396; G02F 1/136209; G02F 2001/136222; G02F 2201/123; G02F 2201/121; G02F 2001/13398; G02F 2001/136295; G02F 1/134309

(57) ABSTRACT

The present invention provides a VA type COA liquid crystal display panel, and the first light shielding layer having red or blue color resist material and the common electrode above the first light shielding layer are correspondingly located above the gate scan line, and the common electrode is electrically coupled to the common electrode layer on the upper substrate, and thus, the voltage difference of the upper, lower substrates is 0 at the gate scan line. Moreover, the panel appears an often black state at the gate scan line because the liquid crystal is not driven by the voltage; besides, the second light shielding layer formed by stacking up two of the red, the green and the blue color resist materials is correspondingly located above the data line; accordingly, the black matrix is eliminated, and the panel aperture ratio is high.

### FIELD OF THE INVENTION

The present invention relates to a liquid crystal display technology field, and more particularly to a VA type COA liquid crystal display panel.

### BACKGROUND OF THE INVENTION

The Liquid Crystal Display (LCD) is one of the most widely utilized flat panel displays, and the liquid crystal display panel is the core component of the Liquid Crystal Display.

The traditional liquid crystal panel generally comprises a Color Filter (CF), a Thin Film Transistor Array Substrate (TFT Array Substrate) and a Liquid Crystal Layer positioned inbetween. The working principle is that the liquid crystal molecules are positioned between the two parallel glass substrates, and many vertical and horizontal tiny little electrical lines are between the two glass substrates, and the light of backlight module is reflected to generate images by applying driving voltages or not for controlling the direction changes of the liquid crystal molecules. The thin film transistor (TFT) array manufactured on the thin film transistor array substrate is employed to drive the liquid crystal to rotate to control the display of each pixel. The color filter substrate comprises RGB color filter layers, which is employed for forming colors of each pixel.

The COA (Color Filter on Array) technology is the skill of directly manufacturing the RGB color filter layers, i.e. the R, G, B color resists on the array substrate, and the color filter substrate is only provided with the Black Matrix (BM) and the Photo Spacer (PS) layer. As shown in FIG. 1, which is a structure diagram of a Vertical Alignment (VA) type COA liquid crystal display panel according to prior art, wherein the color filter layer 11 is located on the TFT substrate 10, and the black matrix 21 and the photo spacers 22 are located on the CF substrate 20.

Because the RGB color resists are manufactured on the TFT array substrate in the COA display panel, no alignment issue of the color filter substrate and the array substrate exists. The difficulty of the cell process in the display panel manufacture process can be reduced to prevent the tolerance of the cell process. Accordingly, the black matrix can be designed to be narrow line width for promoting the aperture ratio of the pixel. The black matrix is mainly to act the light shielding function to prevent the light leakage of the gate control lines and the data lines to raise the contrast of the liquid crystal display panel for achieving the better display result.

For promoting the aperture ratio of the liquid crystal display panel in advance, a BM-less technology is proposed on the basis of the COA technology. Namely, no black matrix layer exists but two color resists of red and blue are employed above the gate control lines and the data lines for light shielding. The BM-less technology is mainly utilized for the In-Plane Switching (IPS) display mode. Because the IPS mode uses the horizontal electrical field to drive the alignment of the liquid crystal, the requirement of flatness for the plane where the electrode is very high. Except the RGB color resists, a transparent light resist is further covered on the color resists for raising the flatness. However, the BM-less technology is not suitable for the Vertical Alignment type display mode. For the VA type liquid crystal display panel, no flat layer covers on the color resists for lowering the cost in general. Then, if stacking up the red, blue color resists above the gate control lines for light shielding, the position of the gate control line will be higher than the display pixel region about a height of one color resist layer. For keeping the panel with a certain thickness, the heights of the photo spacers designed at the positions of the gate control lines will be decreased. The over short photo spacers will lead to that the elastic compression is not enough, and ultimately the space of the display liquid crystal is not enough and the product yield is influenced.

### SUMMARY OF THE INVENTION

An objective of the present invention is to provide a VA type COA liquid crystal display panel, in which under the premise that the elastic compression of the spaces and the cell gap are ensured, the black matrix on the upper substrate is eliminated, and the panel aperture ratio is high, and the manufacture process is simple, and the cost is low.

For realizing the aforesaid objective, the present invention provides a VA type COA liquid crystal display panel, comprising an upper substrate and a lower substrate which are oppositely located, a liquid crystal layer sandwiched between the upper substrate and the lower substrate and sealant employed for seal bonding the upper substrate and the lower substrate;

the lower substrate comprises a TFT substrate, a first passivation layer located on the TFT substrate, a color filter layer, a color shielding layer located on the first passivation layer, a second passivation layer located on the color filter layer and the color shielding layer, a pixel electrode, a common voltage signal line and a common electrode located on the second passivation layer;

the TFT substrate comprises a first substrate, a plurality of gate scan lines, a plurality of data lines, a plurality of TFTs which are located on the first substrate, and the plurality of gate scan lines and the plurality of data lines are mutually insulated and staggered on the first substrate to divide a plurality of pixel regions which are aligned in array;

the color shielding layer comprises a first light shielding layer correspondingly above the plurality of gate scan lines, and a second light shielding layer correspondingly above the plurality of data lines;

the first light shielding layer comprises red color resist material or blue color resist material;

the second light shielding layer is formed by stacking up two of the red color resist material, green color resist material and the blue color resist material;

the common electrode is correspondingly above the plurality of gate scan lines, and is coupled to the common voltage signal line.

The upper substrate comprises a second substrate, a common electrode layer located on the second substrate and a plurality of black photo spacers, a black sealing layer located on the common electrode layer;

both materials of the plurality of black photo spacers and the black sealing layer are black elastic materials;

the plurality of black photo spacers are correspondingly above the plurality of gate scan lines and the plurality of data lines;

the black sealing layer is correspondingly above the sealant.

The black photo spacer comprises main black spacers and auxiliary spacers.

The black photo spacers are conical columns.

The sealant is a conductive sealant, comprising conductive gold balls inside, and the common electrode layer is coupled to the common voltage signal line on the lower substrate through the conductive gold balls in the sealant.

The second light shielding layer is formed by stacking up the red color resist material and the blue color resist material.

The color filter layer comprises a plurality of red, green, blue filter units which are respectively correspondingly located in the plurality of pixel regions, and materials of the plurality of red, green, blue filter units respectively are red, green, blue photoresist materials.

Parts of the color shielding layer and the color filter layer having the same material are formed at the same time.

The plurality of TFTs are correspondingly located in the plurality of pixel regions, and the TFT comprises a gate, a semiconductor layer, a source and a drain;

the lower substrate further comprises a gate isolation layer form on the first substrate and the gates in the plurality of TFTs; the semiconductor layer is formed on the gate isolation layer, and the source and the drain are formed on the gate isolation layer and the semiconductor layer, and the source and the drain respectively contact with two ends of the semiconductor layer;

the first passivation layer and the second passivation layer further comprise a first via correspondingly above the drain, and the pixel electrode is coupled to the drain through the first via.

The plurality of gate scan lines and the gates of the plurality of TFTs are obtained after patterning the same metal layer; the plurality of data lines, the source and the drain of the plurality of TFTs are obtained after patterning the same metal layer; the pixel electrode, the common voltage signal line, the common electrode are obtained after patterning the same transparent conductive layer; material of the transparent conductive layer is ITO.

The present invention further provides a VA type COA liquid crystal display panel, comprising an upper substrate and a lower substrate which are oppositely located, a liquid crystal layer sandwiched between the upper substrate and the lower substrate and sealant employed for seal bonding the upper substrate and the lower substrate;

the lower substrate comprises a TFT substrate, a first passivation layer located on the TFT substrate, a color filter layer, a color shielding layer located on the first passivation layer, a second passivation layer located on the color filter layer and the color shielding layer, a pixel electrode, a common voltage signal line and a common electrode located on the second passivation layer;

the TFT substrate comprises a first substrate, a plurality of gate scan lines, a plurality of data lines, a plurality of TFTs which are located on the first substrate, and the plurality of gate scan lines and the plurality of data lines are mutually insulated and staggered on the first substrate to divide a plurality of pixel regions which are aligned in array;

the color shielding layer comprises a first light shielding layer correspondingly above the plurality of gate scan lines, and a second light shielding layer correspondingly above the plurality of data lines;

the first light shielding layer comprises red color resist material or blue color resist material;

the second light shielding layer is formed by stacking up two of the red color resist material, green color resist material and the blue color resist material;

the common electrode is correspondingly above the plurality of gate scan lines, and is coupled to the common voltage signal line;

wherein the upper substrate comprises a second substrate, a common electrode layer located on the second substrate and a plurality of black photo spacers, a black sealing layer located on the common electrode layer;

both materials of the plurality of black photo spacers and the black sealing layer are black elastic materials;

the plurality of black photo spacers are correspondingly above the plurality of gate scan lines and the plurality of data lines;

the black sealing layer is correspondingly above the sealant;

wherein the black photo spacers comprises main black spacers and auxiliary spacers;

wherein the black photo spacers are conical columns;

wherein the sealant is a conductive sealant, comprising conductive gold balls inside, and the common electrode layer is coupled to the common voltage signal line on the lower substrate through the conductive gold balls in the sealant.

The benefits of the present invention are: the present invention provides a VA type COA liquid crystal display panel, and the first light shielding layer having red or blue color resist material and the common electrode above the first light shielding layer are correspondingly located above the gate scan line, and the common electrode is electrically coupled to the common electrode layer on the upper substrate through the coupling with the common voltage signal line, and thus, the voltage difference of the upper, lower substrates is 0 at the gate scan line. Therefore, the panel appears an often black state at the gate scan line because the liquid crystal is not driven and rotated by the voltage, and besides, the second light shielding layer formed by stacking up two of the red, the green and the blue color resist materials is correspondingly located above the data line; namely, with covering the first light shielding layer and the short circuit between common electrode and common electrode layer of the upper substrate to achieve the light shielding for the gate scan lines, the light leakage at the gate scan lines can be avoided, and with covering the second light shielding layer formed by stacking up two color resist materials on the data lines to achieve the light shielding for the data line, the light leakage at the data lines can be avoided. Moreover, only the first light shielding layer having a single layer of color resist material covers the gate scan lines, the spacer thickness will not be decreased. Accordingly, under the premise that the elastic compression of the spaces and the panel cell gap are ensured, the black matrix on the upper substrate is eliminated, and the panel aperture ratio is high, and the manufacture process is simple, and the cost is low.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a structure diagram of a VA type COA liquid crystal display panel according to prior art;

FIG. 2 is a structure diagram of a VA type COA liquid crystal display panel according to the present invention;

FIG. 3 is a top view diagram of a lower substrate corresponding to a pixel region according to the VA type COA liquid crystal display panel of the present invention;

FIG. 4 is a sectional diagram of the VA type COA liquid crystal display panel according to the present invention at the gate scan line.

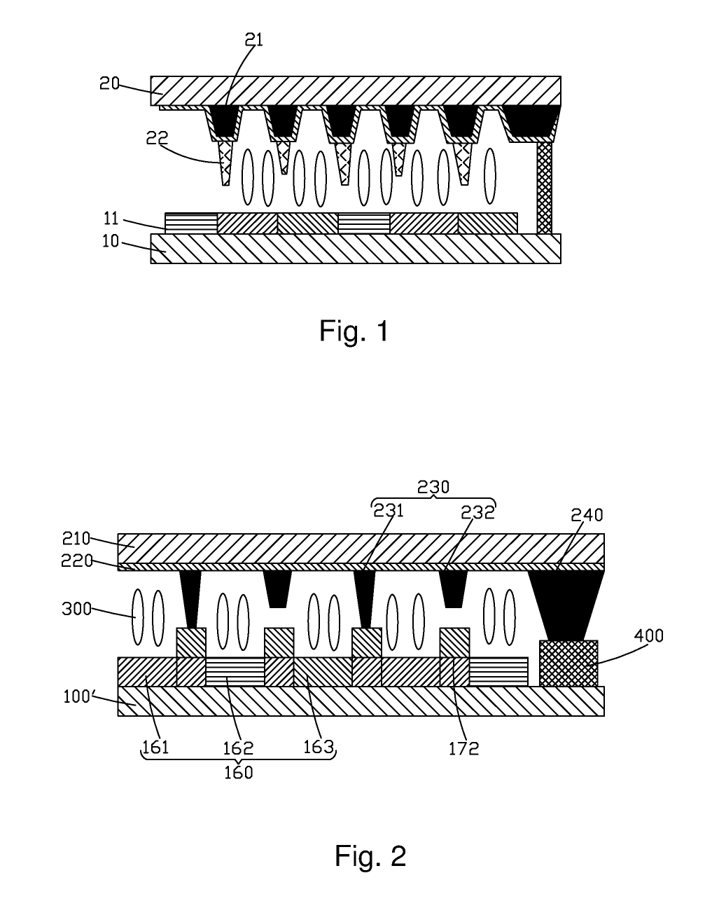

### DETAILED DESCRIPTION OF PREFERRED EMBODIMENTS

For better explaining the technical solution and the effect of the present invention, the present invention will be further described in detail with the accompanying drawings and the specific embodiments.

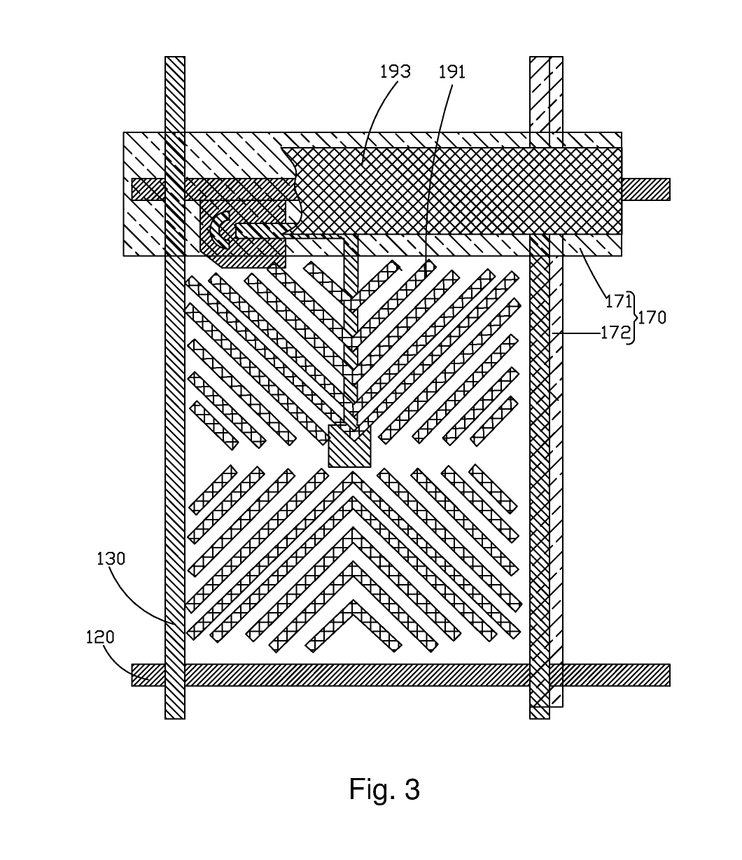

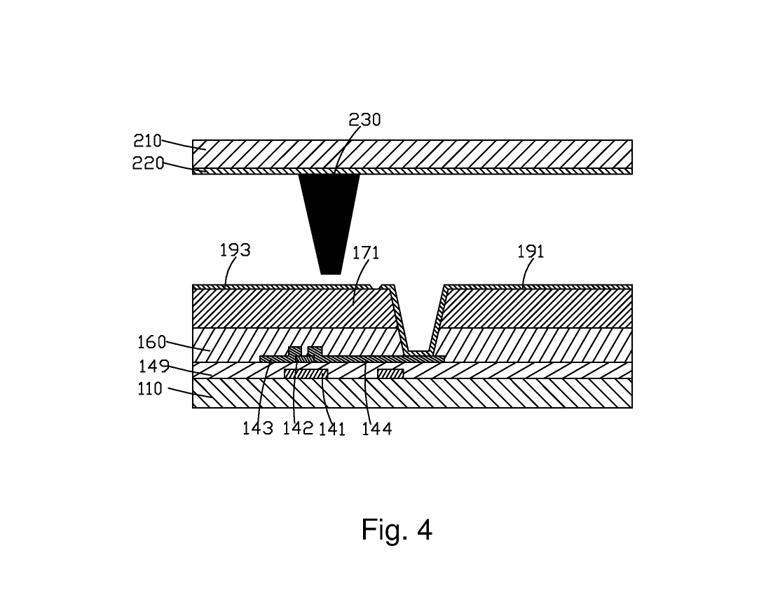

Please refer to FIGS. 2-4. The present invention provides a VA type COA liquid crystal display panel, comprising an upper substrate 200 and a lower substrate 100 which are oppositely located, a liquid crystal layer 300 sandwiched between the upper substrate 200 and the lower substrate 100 and sealant 400 employed for seal bonding the upper substrate 200 and the lower substrate 100;

the lower substrate 100 comprises a TFT substrate 100′, a first passivation layer 150 located on the TFT substrate 100′, a color filter layer 160, a color shielding layer 170 located on the first passivation layer 150, a second passivation layer located on the color filter layer 160 and the color shielding layer 170, a pixel electrode 191, a common voltage signal line and a common electrode 193 located on the second passivation layer;

the TFT substrate 100′ comprises a first substrate 110, a plurality of gate scan lines 120, a plurality of data lines 130, a plurality of TFTs which are located on the first substrate 110, and the plurality of gate scan lines 120 and the plurality of data lines 130 are mutually insulated and staggered on the first substrate 110 to divide a plurality of pixel regions which are aligned in array;

the color shielding layer 170 comprises a first light shielding layer 171 correspondingly above the plurality of gate scan lines 120, and a second light shielding layer 172 correspondingly above the plurality of data lines 130;

the first light shielding layer 171 comprises red color resist material or blue color resist material;

the second light shielding layer 172 is formed by stacking up two of the red color resist material, green color resist material and the blue color resist material;

the common electrode 193 is correspondingly above the plurality of gate scan lines 120, and is coupled to the common voltage signal line.

Specifically, the upper substrate 200 comprises a second substrate 210, a common electrode layer 220 located on the second substrate 210 and a plurality of black photo spacers (BPS) 230, a black sealing layer 240 located on the common electrode layer 220; both materials of the plurality of black photo spacers 230 and the black sealing layer 240 are black elastic materials; the plurality of black photo spacers 230 are correspondingly above the plurality of gate scan lines 120 and the plurality of data lines 130; the black sealing layer 240 is correspondingly above the sealant 400. Consequently, because the plurality of black photo spacers 230 and the black sealing layer 240 are the same material, they can manufactured with the same manufacture process. The black sealing layer 240 can act the light shielding function for the side frame of the liquid crystal panel.

Besides, the first light shielding layer 171 above the gate scan lines 120 is a single layer of color resist material, and does not influence the thickness of the black photo spacers 230, and thus to ensure the elastic compression of the spaces and the panel cell gap of the black photo spacers 230.

Specifically, the black photo spacer 230 comprises main black spacers 231 and auxiliary spacers 232; the black photo spacers 230 are conical columns.

Specifically, the sealant 400 is a conductive sealant, comprising conductive gold balls inside, and the common electrode layer 220 is coupled to the common voltage signal line on the lower substrate 200 through the conductive gold balls in the sealant 400.

In the VA type COA liquid crystal display panel of the present invention, the common electrode 193 is correspondingly above the plurality of gate scan lines 120, and is electrically coupled to the common voltage signal line, and the common electrode layer 220 on the upper substrate is coupled to the common voltage signal line, and thus, the common electrode 193 and the common electrode layer 220 are coupled, and the voltage difference between the two is 0. Then, the panel appears an often black state at the gate scan line because the liquid crystal above the plurality of gate scan lines 120 in the liquid crystal display panel is not driven by the voltage difference; moreover, with combination that the first light shielding layer 171 is located above the plurality of gate scan lines 120, the effective light shielding can be conducted for the plurality of gate scan lines 120 of the display panel; besides, with the second light shielding layer 172 formed by stacking up two color resist materials which is correspondingly located above the plurality of data lines 130, the effective light shielding can be conducted for the plurality of data lines 130 of the display panel; accordingly, under the circumstance without the black matrix, the color mixture among the respective pixel regions of the liquid crystal display panel can be effectively prevented.

Specifically, the color filter layer 160 comprises a plurality of red, green, blue filter units 161, 162, 163 which are respectively correspondingly located in the plurality of pixel regions, and materials of the plurality of red, green, blue filter units 161, 162, 163 respectively are red, green, blue photoresist materials. Besides, the color filter layer 160 also can further comprise a white color light filter unit and a transparent light filter unit.

Specifically, the plurality of TFTs are correspondingly located in the plurality of pixel regions, and the TFT comprises a gate 141, a semiconductor layer 142, a source 143 and a drain 144;

the lower substrate further comprises a gate isolation layer 149 form on the first substrate 110 and the gates 141 in the plurality of TFTs; the semiconductor layer 142 is formed on the gate isolation layer 149, and the source 143 and the drain 144 are formed on the gate isolation layer 149 and the semiconductor layer 142, and the source 143 and the drain 144 respectively contact with two ends of the semiconductor layer 142;

the first passivation layer 150 and the second passivation layer further comprise a via correspondingly above the drain 144, and the pixel electrode 191 is coupled to the drain 144 through the via.

Specifically, the plurality of gate scan lines 120 and the gates 141 of the plurality of TFTs are obtained after patterning the same metal layer; the plurality of data lines 130, the source 143 and the drain 144 of the plurality of TFTs are obtained after patterning the same metal layer; the pixel electrode 191, the common voltage signal line, the common electrode 193 are obtained after patterning the same transparent conductive layer; material of the transparent conductive layer is ITO.

Because the transmission rates of the two kinds of materials, the red and blue color resist materials in the visible light range are smaller, the light shielding result performance is better. Thus, preferably, the second light shielding layer 172 is formed by stacking up the red color resist material and the blue color resist material.

Specifically, parts of the color shielding layer 170 and the color filter layer 160 having the same material are formed at the same time. For example, in one preferred embodiment of the VA type COA liquid crystal display panel according to the present invention, the first light shielding layer 171 comprises the red color resist; the second light shielding layer 172 is formed by stacking up the red color resist material and the blue color resist material; then, as forming the red color filter units 161 of the color filter layer 160, the first light shielding layer 171 has to be formed correspondingly above the plurality of gate scan lines 120 and the part of the red color resist material of the second light shielding layer 172 has to be formed correspondingly above the plurality of data lines 130 among the respective pixel regions; as forming the blue color filter units 163 of the color filter layer 160, the part of the blue color resist material of the second light shielding layer 172 has to be formed correspondingly above the plurality of data lines 130 among the respective pixel regions. Furthermore, in one preferred embodiment of the VA type COA liquid crystal display panel according to the present invention, the first light shielding layer 171 comprises the blue color resist; the second light shielding layer 172 is formed by stacking up the red color resist material and the blue color resist material; then, as forming the blue color filter units 163 of the color filter layer 160, the first light shielding layer 171 has to be formed correspondingly above the plurality of gate scan lines 120 and the part of the blue color resist material of the second light shielding layer 172 has to be formed correspondingly above the plurality of data lines 130 among the respective pixel regions; as forming the red color filter units 161 of the color filter layer 160, the part of the red color resist material of the second light shielding layer 172 has to be formed correspondingly above the plurality of data lines 130 among the respective pixel regions. Therefore, in the VA type COA liquid crystal display panel, the color shielding layer 171 can be manufactured at the same time with the color filter layer 160 without adding the manufacture process. In comparison with the traditional liquid crystal display panel utilizing the black matrix for light shielding, the black matrix material and the black matrix manufacture process can be omitted, and thus to save the production cost and to shorten the production period.

In conclusion, the present invention provides a VA type COA liquid crystal display panel, and the first light shielding layer having red or blue color resist material and the common electrode above the first light shielding layer are correspondingly located above the gate scan line, and the common electrode is electrically coupled to the common electrode layer on the upper substrate through the coupling with the common voltage signal line, and thus, the voltage difference of the upper, lower substrates is 0 at the gate scan line. Therefore, the panel appears an often black state at the gate scan line because the liquid crystal is not driven and rotated by the voltage, and besides, the second light shielding layer formed by stacking up two of the red, the green and the blue color resist materials is correspondingly located above the data line; namely, with covering the first light shielding layer and the short circuit between common electrode and common electrode layer of the upper substrate to achieve the light shielding for the gate scan lines, the light leakage at the gate scan lines can be avoided, and with covering the second light shielding layer formed by stacking up two color resist materials on the data lines to achieve the light shielding for the data line, the light leakage at the data lines can be avoided. Moreover, only the first light shielding layer having a single layer of color resist material covers the gate scan lines, the spacer thickness will not be decreased. Accordingly, under the premise that the elastic compression of the spaces and the panel cell gap are ensured, the black matrix on the upper substrate is eliminated, and the panel aperture ratio is high, and the manufacture process is simple, and the cost is low.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A VA type COA liquid crystal display panel, comprising an upper substrate and a lower substrate which are oppositely located, a liquid crystal layer sandwiched between the upper substrate and the lower substrate and sealant employed for seal bonding the upper substrate and the lower substrate;
the lower substrate comprises a TFT substrate, a first passivation layer located on the TFT substrate, a color filter layer, a color shielding layer located on the first passivation layer, a second passivation layer located on the color filter layer and the color shielding layer, a pixel electrode, a common voltage signal line and a common electrode located on the second passivation layer;
the TFT substrate comprises a first substrate, a plurality of gate scan lines, a plurality of data lines, a plurality of TFTs which are located on the first substrate, and the plurality of gate scan lines and the plurality of data lines are mutually insulated and staggered on the first substrate to divide a plurality of pixel regions which are aligned in array;
the color shielding layer comprises a first light shielding layer correspondingly above the plurality of gate scan lines, and a second light shielding layer correspondingly above the plurality of data lines;
the first light shielding layer comprises red color resist material or blue color resist material;
the second light shielding layer is formed by stacking up two of the red color resist material, green color resist material and the blue color resist material;
the common electrode is correspondingly above the plurality of gate scan lines, and is coupled to the common voltage signal line.

2. The VA type COA liquid crystal display panel according to claim 1, wherein the upper substrate comprises a second substrate, a common electrode layer located on the second substrate and a plurality of black photo spacers, a black sealing layer located on the common electrode layer;
both materials of the plurality of black photo spacers and the black sealing layer are black elastic materials;
the plurality of black photo spacers are correspondingly above the plurality of gate scan lines and the plurality of data lines;
the black sealing layer is correspondingly above the sealant.

3. The VA type COA liquid crystal display panel according to claim 2, wherein the black photo spacers comprises main black spacers and auxiliary spacers.

4. The VA type COA liquid crystal display panel according to claim 2, wherein the black photo spacers are conical columns.

5. The VA type COA liquid crystal display panel according to claim 2, wherein the sealant is a conductive sealant, comprising conductive gold balls inside, and the common electrode layer is coupled to the common voltage signal line on the lower substrate through the conductive gold balls in the sealant.

6. The VA type COA liquid crystal display panel according to claim 2, wherein the second light shielding layer is formed by stacking up the red color resist material and the blue color resist material.

7. The VA type COA liquid crystal display panel according to claim 1, wherein the color filter layer comprises a plurality of red, green, blue filter units which are respectively correspondingly located in the plurality of pixel regions, and materials of the plurality of red, green, blue filter units respectively are red, green, blue photoresist materials.

8. The VA type COA liquid crystal display panel according to claim 6, wherein parts of the color shielding layer and the color filter layer having the same material are formed at the same time.

9. The VA type COA liquid crystal display panel according to claim 1, wherein the plurality of TFTs are correspondingly located in the plurality of pixel regions, and the TFT comprises a gate, a semiconductor layer, a source and a drain;
the lower substrate further comprises a gate isolation layer form on the first substrate and the gates in the plurality of TFTs; the semiconductor layer is formed on the gate isolation layer, and the source and the drain are formed on the gate isolation layer and the semiconductor layer, and the source and the drain respectively contact with two ends of the semiconductor layer;
the first passivation layer and the second passivation layer further comprise a via correspondingly above the drain, and the pixel electrode is coupled to the drain through the via.

10. The VA type COA liquid crystal display panel according to claim 9, wherein the plurality of gate scan lines and the gates of the plurality of TFTs are obtained after patterning the same metal layer; the plurality of data lines, the source and the drain of the plurality of TFTs are obtained after patterning the same metal layer; the pixel electrode, the common voltage signal line, the common electrode are obtained after patterning the same transparent conductive layer; material of the transparent conductive layer is ITO.

11. A VA type COA liquid crystal display panel, comprising an upper substrate and a lower substrate which are oppositely located, a liquid crystal layer sandwiched between the upper substrate and the lower substrate and sealant employed for seal bonding the upper substrate and the lower substrate;
the lower substrate comprises a TFT substrate, a first passivation layer located on the TFT substrate, a color filter layer, a color shielding layer located on the first passivation layer, a second passivation layer located on the color filter layer and the color shielding layer, a pixel electrode, a common voltage signal line and a common electrode located on the second passivation layer;
the TFT substrate comprises a first substrate, a plurality of gate scan lines, a plurality of data lines, a plurality of TFTs which are located on the first substrate, and the plurality of gate scan lines and the plurality of data lines are mutually insulated and staggered on the first substrate to divide a plurality of pixel regions which are aligned in array;
the color shielding layer comprises a first light shielding layer correspondingly above the plurality of gate scan lines, and a second light shielding layer correspondingly above the plurality of data lines;
the first light shielding layer comprises red color resist material or blue color resist material;
the second light shielding layer is formed by stacking up two of the red color resist material, green color resist material and the blue color resist material;
the common electrode is correspondingly above the plurality of gate scan lines, and is coupled to the common voltage signal line;
wherein the upper substrate comprises a second substrate, a common electrode layer located on the second substrate and a plurality of black photo spacers, a black sealing layer located on the common electrode layer;
both materials of the plurality of black photo spacers and the black sealing layer are black elastic materials;
the plurality of black photo spacers are correspondingly above the plurality of gate scan lines and the plurality of data lines;
the black sealing layer is correspondingly above the sealant;
wherein the black photo spacers comprises main black spacers and auxiliary spacers;
wherein the black photo spacers are conical columns;
wherein the sealant is a conductive sealant, comprising conductive gold balls inside, and the common electrode layer is coupled to the common voltage signal line on the lower substrate through the conductive gold balls in the sealant.

12. The VA type COA liquid crystal display panel according to claim 11, wherein the second light shielding layer is formed by stacking up the red color resist material and the blue color resist material.

13. The VA type COA liquid crystal display panel according to claim 11, wherein the color filter layer comprises a plurality of red, green, blue filter units which are respectively correspondingly located in the plurality of pixel regions, and materials of the plurality of red, green, blue filter units respectively are red, green, blue photoresist materials.

14. The VA type COA liquid crystal display panel according to claim 12, wherein parts of the color shielding layer and the color filter layer having the same material are formed at the same time.

15. The VA type COA liquid crystal display panel according to claim 11, wherein the plurality of TFTs are correspondingly located in the plurality of pixel regions, and the TFT comprises a gate, a semiconductor layer, a source and a drain;
the lower substrate further comprises a gate isolation layer form on the first substrate and the gates in the plurality of TFTs; the semiconductor layer is formed on the gate isolation layer, and the source and the drain are formed on the gate isolation layer and the semiconductor layer, and the source and the drain respectively contact with two ends of the semiconductor layer;
the first passivation layer and the second passivation layer further comprise a via correspondingly above the drain, and the pixel electrode is coupled to the drain through the via.

16. The VA type COA liquid crystal display panel according to claim 15, wherein the plurality of gate scan lines and the gates of the plurality of TFTs are obtained after patterning the same metal layer; the plurality of data lines, the source and the drain of the plurality of TFTs are obtained after patterning the same metal layer; the pixel electrode, the common voltage signal line, the common electrode are obtained after patterning the same transparent conductive layer; material of the transparent conductive layer is ITO.
